(19) United States
(12) Patent Application Publication
(10) Pub. No.: US 2006/0098134 A1
(43) Pub. Date: May 11, 2006

(54) Liquid crystal display device and portable display device

(76) Inventors: Young Woo Park, Seoul (KR); Young Kwang Ha, Jinju-shi (KR); In Ja Oh, Seoul (KR)

Correspondence Address: MCKENNA LONG & ALDRIDGE LLP, 1900 K STREET, NW, WASHINGTON, DC, 20006, US

(21) Appl. No.: 11/167,100

(22) Filed: Jun. 28, 2005

(30) Foreign Application Priority Data
Nov. 10, 2004 (KR) P2004-91300

(51) Int. Cl. G02F 1/1333

(52) U.S. Cl. 349/58

(57) ABSTRACT

A liquid crystal display (LCD) device and portable display device are disclosed. The LCD device includes an LCD panel; a top case covering a periphery of the LCD panel; and a connection member between the LCD panel and the top case to provide an electrical contact between the LCD panel and the top case.

This application claims the benefit of the Korean Patent Application No. P2004-91300, filed on Nov. 10, 2004, which is hereby incorporated by reference as if fully set forth herein.

### BACKGROUND OF THE INVENTION

1. Field of the Invention

The present invention relates to a display device and portable display device, and more particularly, to a liquid crystal display (LCD) device having a spring or other compressing means to electrically ground the display panel without using a separate conductive tape.

2. Discussion of the Related Art

Generally, a liquid crystal display device includes a liquid crystal display module, a drive circuit unit for driving the liquid crystal display module, and a case. The liquid crystal display (LCD) module includes an LCD panel and a backlight unit for applying light to the LCD panel. The LCD panel includes a plurality of liquid crystal cells arranged in a matrix form in a pair of glass substrates between which liquid crystal is provided and switching devices for switching signals supplied to the liquid crystal cells. Moreover, optical sheets are arranged on the LCD module to direct the light emitted from the backlight unit toward the LCD panel.

The LCD panel, backlight unit and optical sheets are joined in one body to prevent a light loss and to be protected against external shocks. For this end, a top case is provided to enclose an edge of the LCD panel, the backlight unit and the optical sheets.

The drive circuit unit is mounted on a printed circuit board (hereinafter abbreviated as PCB) to drive the LCD panel. A tape carrier package (hereinafter abbreviated as TCP) is generally used to connect the LCD panel with the PCB for signal transfer. The TCP is directly attached to the lower substrate of the LCD panel and the PCB using a conductive resin. The TCP includes a flexible layer of polyimide and the like and a metal-based conductive layer embedded in the flexible layer to form a mono- or multi-layer structure.

As described above, the LCD module including a glass substrate is vulnerable to external shocks. To protect the LCD panel from the external shocks, the top case is used to enclose an exterior of the LCD module.

A liquid crystal display (LCD) device according to the related art will now be described with reference to the accompanying drawings. FIG. 1 illustrates a layout of an LCD device according to the related art and FIG. 2 is a cross-sectional view taken along the cutting line I-I′ in FIG. 1.

Referring to FIG. 1 and FIG. 2, an LCD device according to the related art includes a reflector 42, a light guide plate 44, a plurality of optical sheets 46 stacked on the light guide plate 44, an LCD panel 48 having a pair of substrates facing each other and first and second polarizing plates 40a and 40b provided on the backsides of the substrates, a plastic main support 34, and a top case and bottom cover 32 and 36 enclosing the main support 34 and an edge of the LCD panel 48.

The LCD device uses a Cu- or Al-sided conductive tape 38. A conductive metal is formed on one surface of the conductive tape 38 and an adhesive substance is coated on the other surface of the conductive tape 38. When the adhesive portion of the conductive tape 38 is attached to the top case 32, the metal surface of the conductive tape 38 contacts a upper glass substrate of the LCD panel 48, the main support 34 and the bottom cover 36. The conductive tape 38 discharges static electricity generated from the LCD panel 48 to the bottom cover 36.

However, the LCD device according to the related art has the following problems. First of all, adhesion failure of the conductive tape occurs due to mass production of the LCD devices. The conductive tape is attached to a narrow area of the LCD panel and exposed to an environment of high temperature and vibration during the fabrication process of the LCD process. Thus, the adhesiveness of the conductive tape is weakened so that the conductive tape is easily detached from the LCD panel, which creates a grounding defect between the LCD panel and the bottom cover and stains on the LCD panel.

### SUMMARY OF THE INVENTION

Accordingly, the present invention is directed to a liquid crystal display device and portable display device that substantially obviate one or more problems due to limitations and disadvantages of the related art.

An advantage of the present invention is to provide a liquid crystal display device and portable display device having a spring or other compressing means to electrically ground the display panel without using a separate conductive tape.

Additional advantages and features of the invention will be set forth in part in the description which follows and in part will become apparent to those having ordinary skill in the art upon examination of the following or may be learned from practice of the invention. These and other advantages of the invention may be realized and attained by the structure particularly pointed out in the written description and claims hereof as well as the appended drawings.

To achieve these and other advantages and in accordance with the purpose of the invention, as embodied and broadly described herein, a liquid crystal display (LCD) device according to the present invention includes an LCD panel; a top case covering a periphery of the LCD panel; and a connection member between the LCD panel and the top case to provide an electrical contact between the LCD panel and the top case.

In another aspect of the present invention, a liquid crystal display (LCD) device includes an LCD panel; a top case covering a periphery of the LCD panel; and a compressing means for grounding the LCD panel to the top case.

In yet another aspect of the present invention, a liquid crystal display (LCD) device includes an LCD panel; a top case covering a periphery of the LCD panel; an insulating main support supporting the LCD panel; and a compressing member having an electric contact with at least one of the top case, the LCD panel and the insulating main support.

In still another aspect of the present invention, a portable display device includes a display panel; a top case covering a periphery of the display panel; an insulating main support supporting the display panel; and an electrically conductive elastic member contacting the top case to ground the display panel to the top case.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention.

In the drawings:

FIG. 1 illustrates a layout of an LCD device according to the related art;

FIG. 2 is a cross-sectional view taken along the cutting line I-I′ in FIG. 1;

FIG. 3 is a perspective view illustrating a plate spring applied to an LCD device according to the present invention;

FIG. 4 is a perspective view illustrating a top case to which the plate spring of FIG. 3 is attached;

FIG. 5 is a detailed view of a part B in FIG. 4;

FIG. 6 is a cross-sectional view taken along the cutting lines II-II′ in FIG. 4 and FIG. 5;

FIG. 7A and FIG. 7B are perspective views illustrating a plate spring attached to a top case in an LCD device;

FIG. 8A and FIG. 8B are perspective views illustrating a plate spring before and after assembling an LCD panel to a case top, respectively;

FIG. 9 is a perspective view illustrating an LCD device according to another embodiment of the present invention and; and

FIG. 10 is a cross-sectional view taken along the cutting line III-III′ in FIG. 9.

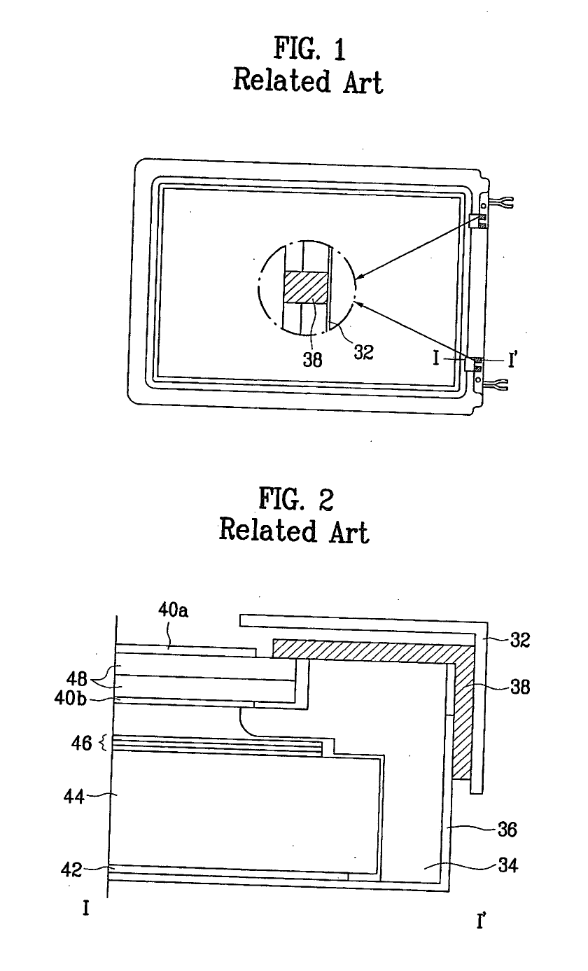

### DETAILED DESCRIPTION OF THE INVENTION

Reference will now be made in detail to embodiments of the present invention, examples of which are illustrated in the accompanying drawings. Wherever possible, the same reference numbers will be used throughout the drawings to refer to the same or like parts.

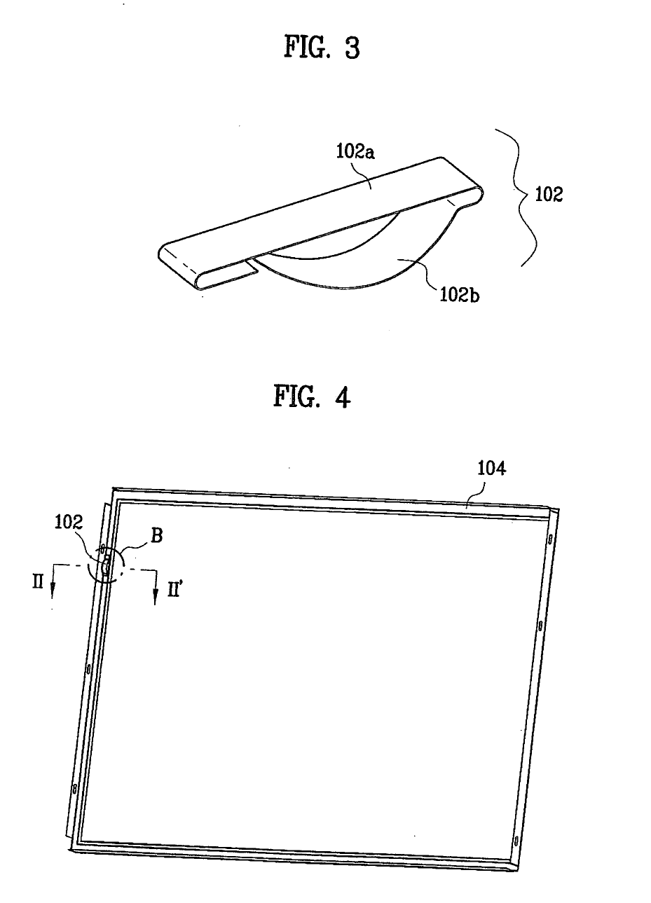

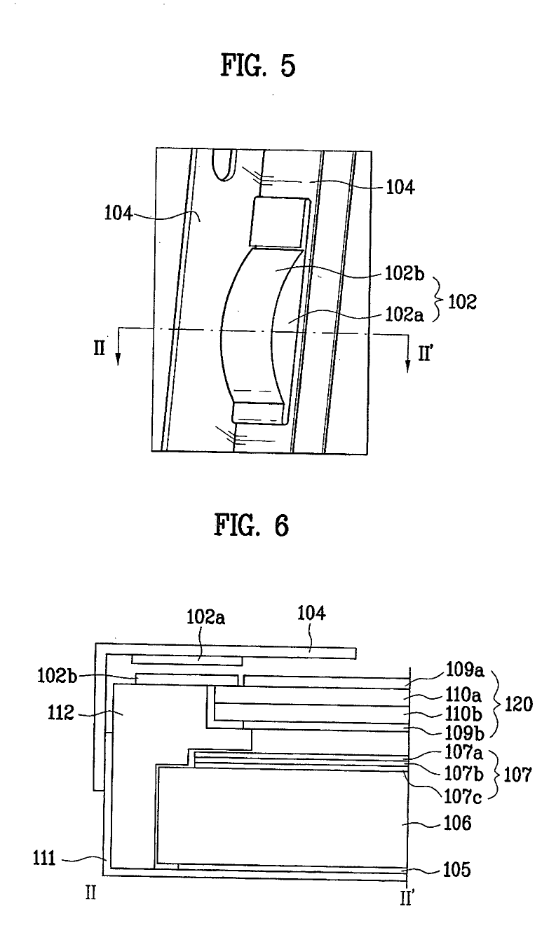

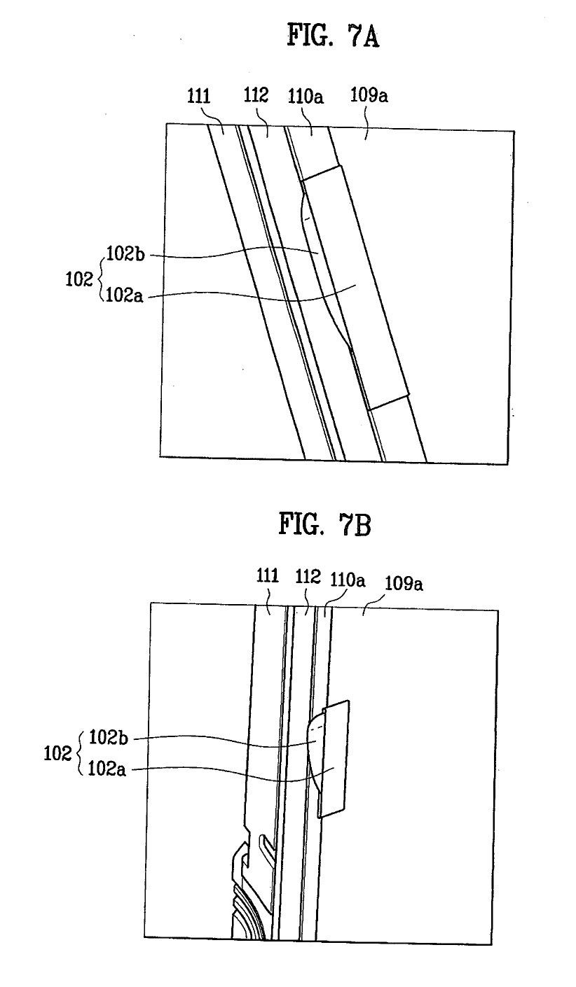

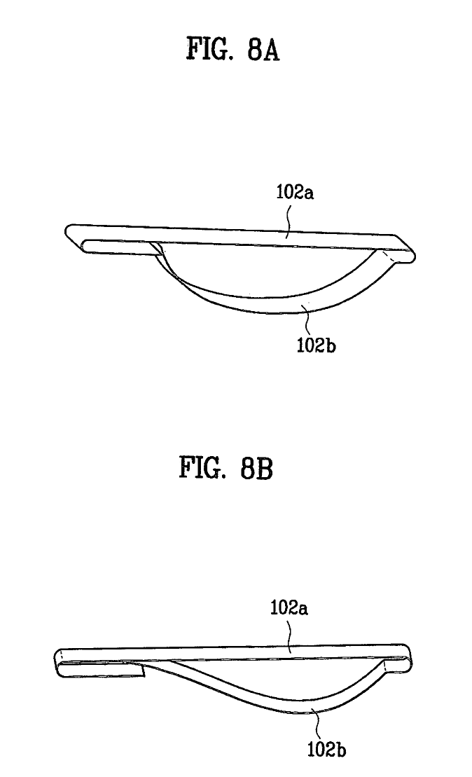

FIGS. 3 to 8B illustrate a liquid crystal display (LCD) device or portable display device (a display device small and light enough to be carried personally, for example, a laptop computer) according to an embodiment of the present invention. FIG. 3 is a perspective view illustrating a plate spring applied to an LCD device according to the present invention, FIG. 4 is a perspective view illustrating a top case to which the plate spring in FIG. 3 is attached, and FIG. 5 is a detailed view of a part B in FIG. 4. FIG. 6 is a cross-sectional view taken along the cutting lines II-II′ in FIG. 4 and FIG. 5. FIG. 7A and FIG. 7B are perspective views illustrating a plate spring attached to a top case in an LCD device and FIG. 8A and FIG. 8B are perspective views illustrating a plate spring before and after assembling an LCD panel to a case top.

Referring to FIGS. 3 to 8B, an LCD device according to the present invention includes an LCD panel 120 and a non-conductive main support 112 for supporting the LCD panel 120. The LCD panel 120 includes first and second glass substrates 110a and 110b facing each other. First and second polarizing plates 109a and 109b are formed on surfaces (backsides) of the first and second glass substrates 110a and 110b, respectively. A plurality of switching devices are formed on the second glass substrate 110b to switch signals supplied to liquid crystal cells. In addition, a color filter layer, a black matrix and/or a common electrode are, for example, formed on the first glass substrate 110a.

The LCD device further includes a backlight unit having a light guide plate 106, a reflector 105, and an optical sheet 107. The light guide plate 106 guides the light generated from an area corresponding to the size of the LCD panel 120. The reflector 105 is arranged under the light guide plate 106 and contacts the light guide plate 106. The reflector 105 reflects the light from the light guide plate 106 toward the LCD panel 120. As illustrated in FIG. 6, the reflector 105 is smaller than the light guide plate 106 so that end portions of the reflector 105 and light guide plate 106 do not coincide with each other. However, the reflector 105 can be larger than the light guide plate 106 according to another embodiment of the present invention, as illustrated FIG. 10.

The optical sheet 107 is arranged between the light guide plate 106 and the LCD panel 120 and includes a plurality of individual sheets such as first and second prism sheets 107a and 107b neighboring to each other, a diffuser 107c and the like. The optical sheet 107 refracts the light from the light guide plate 106 toward the LCD panel 120. The diffuser 107c spreads the light from the light guide plate 106 and the first and second prism sheets 107a and 107b uniformly disperse the light reaching the LCD panel 120 to improve the luminance of the LCD device in a viewing direction.

The LCD panel 120, the light guide plate 106 and the optical sheet 107 are joined together to minimize a light loss and protect the LCD device from external shocks. Because the LCD panel 120 includes the first and second glass substrates 110a and 110b, which are fragile against the external shocks, the top case 104 encloses edges of the LCD panel, light guide and optical sheet 120, 106 and 107 to minimize a light loss and protect the LCD device from the external shocks. In particular, the top case 104 is secured to the main support 112 to enclose the edges of the LCD panel 120.

The main support 112 is, for example, formed of plastic and formed by a molding process. The main support 112 has at least one or more steps formed on its inner sidewall. The LCD panel 120 is placed on one of the steps. In the drawings, the second polarizing plate 109b contacts the main support 112, but a periphery of the second glass substrate 110b may contact the main support 112 in another embodiment. Moreover, the main support 112 has at least one or more steps corresponding to the light guide plate 106 and the optical sheet 107. Although not shown in FIG. 6, a lamp or other light source can be fitted in one of the steps of the main support, as illustrated in FIG. 10.

The top case 104 encloses a periphery of the LCD panel 120 to be in contact with the bottom cover 111. Each of the top case 104 and the bottom cover 111 is formed of a metal-based material such as stainless steel. The bottom cover 111 is secured to the main support 112 by screws or other means. The bottom cover 111 has a rectangular frame shape having a front portion and a side portion vertical to the front portion to cover the edges of the LCD panel 120. The top case 104 does not directly contact the LCD panel 120 or the main support 112.

Referring to FIG. 3 and FIG. 5, the plate spring 102 formed of an elastic conductive material is attached to a predetermined portion of the top case 104. In particular, the plate spring 102 includes a first face 102a that is substantially flat and a second face 102b that has an arc shape. An end portion of the first face 102a is connected to the second face 102b. The first face 102a is attached to a upper surface of the top case 104 via a two-sided conductive tape, soldering, a snap-fit, at least one screw or the like. The second face 102b contacts the main support 112 via a conductive tape, soldering or the like. Alternatively, the second face 102b may only contact the first glass substrate 110a without being attached to the main support 112.

FIG. 8A and FIG. 8B illustrate the plate spring 102 before and after the LCD panel 120 is assembled to the top case 104, in which other portions of the LCD device or the top case 104 are not shown.

Referring to FIG. 8A and FIG. 8B, an end portion of the first face has a ‘U’-shape in a side view. Before the plate spring 102 is attached to the top case 104, an end portion of the second face 102b does not contact the U-shaped end portion of the first face 102a. When the plate spring 102 is attached to the top case 104, a middle portion of the second face 102b having an arc shape is pushed up so that the end portion of the second face 102b extends to and contacts the U-shaped end portion of the first shape 102a.

A positional relationship between the plate spring 102 and other parts is illustrated in FIG. 7A and FIG. 7B, when the plate spring 102 is attached to the top case 104. The top case 104 is omitted in FIG. 7A and FIG. 7B. When the plate spring 102 is attached to the top case 104, the backside of the second face 102b of the plate spring 102 contacts a periphery of the LCD panel 120. The backside of the second face 102b contacts the first glass substrate 110a extended relatively longer than the first polarizing plate 109a and a upper portion of the main support 112. As illustrated in the drawings, the bottom cover 111 encloses side and bottom portions of the main support 112.

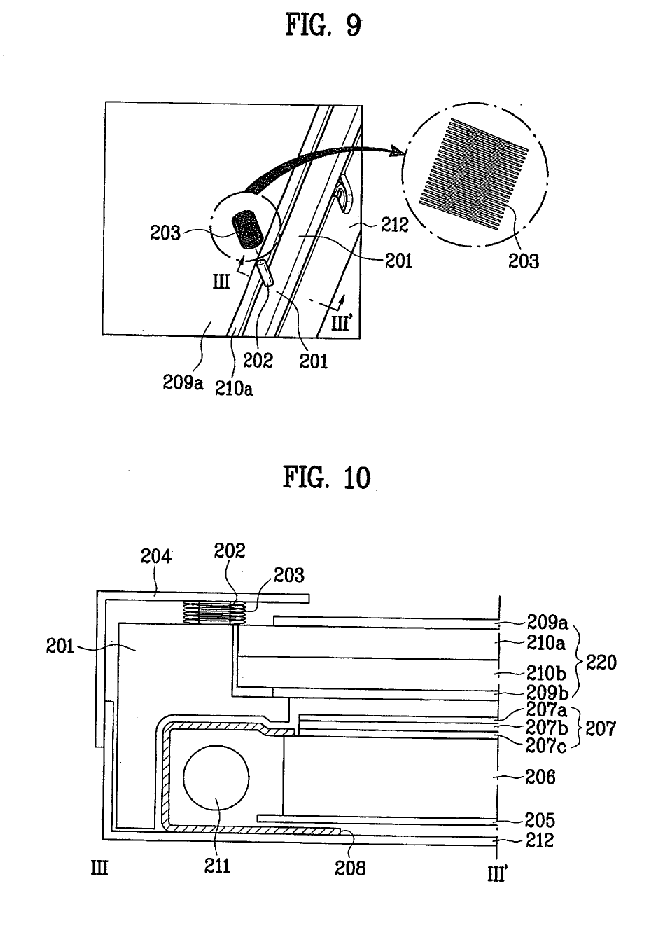

FIG. 9 is a perspective view illustrating an LCD device according to another embodiment of the present invention and FIG. 10 is a cross-sectional view taken along the cutting line III-III′ in FIG. 9.

Referring to FIG. 9, an LCD device according to another embodiment of the present invention, similar to the former embodiment of the present invention, includes an LCD panel 220 and a main support 201 formed of a non-conductive substance to support the LCD panel 220. The LCD panel 220 includes first and second glass substrates 210a and 210b facing each other. First and second polarizing plates 209a and 209b are formed on surfaces (backsides) of the first and second glass substrates 210a and 210b, respectively. A plurality of switching devices are formed on the second glass substrate 210b to switch signals supplied to liquid crystal cells. In addition, a color filter layer, a black matrix and/or a common electrode are, for example, formed on the first glass substrate 210a.

The LCD device further includes a backlight unit having a light source 211, a light guide plate 206, a reflector 205, and an optical sheet 207. The light guide plate 206 guides the light generated from an area corresponding to the size of the LCD panel 220. The light source 211 is arranged in the vicinity of an end portion of the light guide plate 206. The light source 211 is enclosed by a lamp housing 208 that reflects the light from the light source 211 toward the light guide 206. The reflector 205 is arranged under the light guide plate 206 and contacts the light guide plate 206. The reflector 205 reflects the light from the light guide plate 206 toward the LCD panel 220 and is extended longer than the end portion of the light guide plate 206. The lamp housing 208 encloses the side of the light guide plate 206 that faces the lamp 211. Thus, the lamp housing 208 is partially overlapped with the reflector 205. Alternatively, a plurality of light sources can be provided at more than two sides of the light guide plate 206. Alternatively, a plurality of light sources can be arranged under the optical sheet in an array form without employing a light guide plate.

The optical sheet 207 is arranged between the light guide plate 206 and the LCD panel 220 and includes a plurality of individual sheets such as first and second prism sheets 207a and 207b neighboring to each other, a diffuser 207c and the like. The optical sheet 207 refracts the light from the light guide plate 206 toward the LCD panel 220.

The LCD panel 220, the light guide plate 206 and the optical sheet 207 are joined together to minimize a light loss and protect the LCD device from external shocks. Because the LCD panel 220 includes the first and second glass substrates 210a and 210b, which are fragile against the external shocks, the top case 204 encloses edges of the LCD panel, light guide and optical sheet 220, 206 and 207 to minimize the light loss and protect the LCD device from external shocks. In particular, the top case 204 is secured to the main support 201 to enclose the edges of the LCD panel 220.

The main support 201 is, for example, formed of plastic and formed by a molding process. The main support 201 has at least one or more steps formed on its inner sidewall. In particular, the second polarizing plate 209b, as illustrated in the drawing, contacts the main support 201. Alternatively, a periphery of the second glass substrate 210b may contact the main support 112, as illustrated in FIG. 6. Moreover, the main support 201 has at least one or more steps corresponding to the light source 211. The main support 201 has a projection 202 extending from its upper surface, which can be formed during the molding process of the main support 201. Alternatively, the projection 201 can be attached to the main support 201 after completion of the molding process. The light source 211 and the lamp housing 208 can be secured to the main support 201 by screws, an adhesive agent, soldering or the like.

The top case 204 encloses a periphery of the LCD device to be in contact with the bottom cover 212. Each of the top case 204 and the bottom cover 212 is formed of a metal-based material such as stainless steel. The bottom cover 212 is attached to the main support 201 by screws or other means. The bottom cover 212 has a rectangular frame shape having a front portion and a side portion vertical to the front portion to cover the edges of the LCD panel 220. The top case 204 is attached to the LCD panel 220 when assembling the LCD device. The top case does not directly contact the LCD panel 220 or the main support 201.

A coil spring 203 formed of an elastic conductive material is arranged to encase the projection 202 of the main support 201. The coil spring 203 is attached to the LCD panel 220 together with the top case 204 during the assembly. In particular, a upper part of the coil spring 203 contacts the top case 204 and a lower part of the coil spring 203 contacts the main support 201 and the first glass substrate 201a. The coil spring 203 electrically grounds the LCD panel 220 to the top case 204 to prevent static electricity from being concentrated on the LCD panel 220. Although a set of the projection 202 and the coil spring 203 is illustrated in the drawings, a plurality of sets of a projection and a coil spring can be used. The coil spring 203 can have any shape and size, so long as it contacts the main support 201, the first glass substrate 210a and the top case 204 during the assembly. The upper and lower parts of the coil spring 203 can be attached to the top case 204 and/or the main support 201 and/or the first glass substrate 210a in the similar manner described above with respect to the plate spring 102 of the former embodiment of the present invention.

The plate or coil spring discharges static electricity, which is, for example, generated when loading the LCD panel within the top case during the assembly process of the LCD device, to the top case, thereby protecting the LCD panel from the static electricity. Thus, the LCD device of the present invention can use the spring or other compressing means to electrically ground the LCD panel without using a separate conductive tape.

Accordingly, the present invention provides the following advantages. First of all, an electrically conductive path, via which static electricity is discharged, is formed by the spring (coil or plate) contacting the top case and a periphery of the LCD panel, whereby the LCD panel can be protected against static electricity. Secondly, because the LCD panel is electrically grounded to the top case via the spring (coil or plate), product failure caused by the defective conductive tape can be minimized.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A liquid crystal display (LCD) device comprising:
an LCD panel;
a top case covering a periphery of the LCD panel; and
a connection member between the LCD panel and the top case to provide an electrical contact between the LCD panel and the top case.

2. The LCD device of claim 1, further comprising an insulating main support supporting the LCD panel and contacting the connection member.

3. The LCD of claim 2, wherein the main support has a projection.

4. The LCD device of claim 3, wherein the projection is fitted in the connection member.

5. The LCD device of claim 2, wherein the LCD panel includes a pair of substrates facing each other, and wherein one of the substrates contacts the main support.

6. The LCD device of claim 1, wherein the connection member is one of a plate spring and a coil spring.

7. The LCD device of claim 1, wherein the connection member is attached to the top case.

8. The LCD device of claim 1, wherein the connection member is attached to the LCD panel.

9. The LCD device of claim 1, wherein the connection member is formed of an elastic substance.

10. The LCD device of claim 1, wherein the connection member is formed of a compressible substance.

11. A liquid crystal display (LCD) device comprising:
an LCD panel;
a top case covering a periphery of the LCD panel; and
a compressing means for grounding the LCD panel to the top case.

12. The LCD device of claim 11, wherein the compressing means provides a physical contact between the LCD panel and the top case.

13. The LCD device of claim 11, further comprising an insulating main support supporting the LCD panel and contacting the compressing means.

14. The LCD device of claim 13, wherein the compressing means provides a physical contact between the LCD panel and the main support.

15. The LCD device of claim 13, wherein the compressing means is laterally held by the main support.

16. The LCD device of claim 11, wherein the compressing means is formed of a non-adhesive substance.

17. The LCD device of claim 11, wherein the compressing means is attached to the top case.

18. The LCD device of claim 11, wherein the compressing means is formed of an elastic substance.

19. A liquid crystal display (LCD) device comprising:
an LCD panel;
a top case covering a periphery of the LCD panel;
an insulating main support supporting the LCD panel; and
a compressing member having an electric contact with at least one of the top case, the LCD panel and the insulating main support.

20. The LCD device of claim 19, wherein the compressing member contacts with at least one of the LCD panel and the main support.

21. The LCD device of claim 19, wherein the compressing member contacts the LCD panel and the main support.

22. The LCD device of claim 19, wherein the compressing member is laterally held by the main support.

23. The LCD device of claim 22, wherein the main support further comprises a projection laterally holding the compressing member.

24. The LCD device of claim 23, wherein the compressing member comprises a coil arranged on the projection.

25. The LCD device of claim 19, wherein the LCD panel comprises a pair of substrates facing each other, and wherein one of the substrates contacts the main support.

26. The LCD device of claim 19, wherein the compressing member comprises a plate spring.

27. The LCD device of claim 19, wherein the compressing member is attached to the top case.

28. The LCD device of claim 19, wherein the compressing member is attached to the LCD panel.

29. The LCD device of claim 19, wherein the compressing member is elastic.

30. A portable display device comprising:
a display panel;
a top case covering a periphery of the display panel;
an insulating main support supporting the display panel; and
an electrically conductive elastic member contacting the top case to ground the display panel to the top case.

31. The portable display device of claim 30, wherein the electrically conductive elastic member physically contacts the display panel.

32. The portable display device of claim 31, wherein the electrically conductive elastic member physically contacts the main support.

33. The portable display device of claim 30, wherein the electrically conductive elastic member is laterally held by the main support.

34. The portable display device of claim 33, wherein the main support comprises an extension laterally holding the electrically conductive elastic member.

35. The portable display device of claim 34, wherein the electrically conductive elastic member is provided to the extension of the main support.
